(19) United States
(12) Patent Application Publication
(10) Pub. No.: US 2001/0046553 A1
(43) Pub. Date: Nov. 29, 2001

(54) PROCESS FOR FORMING A PHOSPHOR SCREEN FOR DISPLAY

(76) Inventors: AKIO UMEMOTO, ASHIGARAKAMI-GUN (JP); NORIO MIURA, ISEHARA-SHI (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/371,009

(22) Filed: Aug. 10, 1999

(30) Foreign Application Priority Data
Aug. 11, 1998 (JP) 10-226433

(51) Int. Cl. B05D 5/06; B05D 1/36; B05D 1/32

(52) U.S. Cl. 427/68; 427/282; 427/402

(57) ABSTRACT

A process for forming a phosphor screen for display having a substrate, and at least a black matrix layer and a phosphor layer formed on the substrate, which comprises firstly forming the black matrix layer on the substrate by photolithography, and then coating a phosphor-containing ink composition by a screen printing method by using a screen mask corresponding to the phosphor layer pattern, to form the phosphor layer on the substrate.

### BACKGROUND OF THE INVENTION

1. Field of the Invention

The present invention relates to a process for forming a phosphor screen for display device (display). Particularly, the present invention relates to an improvement in a process for forming a phosphor screen for a flat panel display (FPD) such as a field emission display (FED), an electroluminescent display (ELD) or a flat cathode ray tube (flat CRT) by using a screen printing method.

2. Discussion of Background

A phosphor screen for display such as a cathode ray tube (CRT) is usually formed by photolithography. Firstly, a phosphor coating slurry containing a phosphor and a photosensitive resin having ammonium dichromate added to a water-soluble high polymer such as PVA, i.e. a phosphor-containing photo-resist slurry, is coated in a prescribed pattern on a face plate of e.g. glass, followed by irradiation with lights to cure the photosensitive resin (exposure step), and the coated surface is washed with water to wash off the unexposed slurry (development step) to form a phosphor screen.

For a color display, four kinds of layers i.e. three color phosphor layers containing red, blue and green emitting phosphors, respectively, and a photo-absorbing layer (black matrix, hereinafter referred to as “BM”) are formed in a prescribed pattern on a face plate. To increase the contrast of the displayed image, the BM layer is formed by filling a photo-absorbing substance along the periphery (spacing) of each color phosphor layer. Each color phosphor layer comprises one of three phosphors having different luminescent colors, and it is in a form of dots, rectangles or stripes. The BM layer is formed to fill the spacings around each phosphor layer which is in a form of dots, rectangles or stripes.

On the contrary, a phosphor screen for flat display such as FED or ELD, has a flat surface, and accordingly, the phosphor screen can be formed by a screen printing method. Namely, it is common to form a phosphor layer in such a manner that a phosphor is dispersed in a binder resin to prepare a paste-like phosphor-containing ink composition, and the ink composition is coated on a substrate in a prescribed pattern by a screen printing method by using a screen mask.

In such a method for forming a phosphor screen for display by a screen printing method, development steps (such as washing and removal) which are necessary for photolithography, are not required. Accordingly, equipment for layer formation can be simplified, and the loss of the phosphor is extremely small, such being advantageous.

However, when the BM layer is formed by a screen printing method, the BM layer tends to be irregular, the edges of the BM layer tend to be dim, and the linearity of the contours of the BM layer tends to be poor, whereby uniformity of the phosphor screen will deteriorate. Further, if the BM layer is contaminated by a trace of extraneous substance such as dust, defects on appearance are likely to result. Improvements in these respects have been desired.

### SUMMARY OF THE INVENTION

Under these circumstances, it is an object of the present invention to overcome the above-mentioned drawbacks, and to provide a process for forming a phosphor screen for display which has a uniform phosphor layer and a sharp boundary between each color phosphor layer and the BM layer, which has no defect in the phosphor layer or the BM layer, which accurately reproduces a desired phosphor layer pattern, and which has a high-resolution without cross contamination.

The present inventors have found that at the time of forming a phosphor screen for color display, by firstly forming the BM layer alone by photolithography, and then forming the phosphor layer by a screen printing method, a uniform phosphor screen with high-resolution, having no irregularities on the phosphor layer or the BM layer, and having sharp edges, can be obtained, and the present invention has been accomplished. Namely, the constitutions of the present invention are as follows.

(1) A process for forming a phosphor screen for display having a substrate, and at least a black matrix (BM) layer and a phosphor layer formed on the substrate, which comprises firstly forming the black matrix (BM) layer on the substrate by photolithography, and then coating a phosphor-containing ink composition by a screen printing method by using a screen mask corresponding to the phosphor layer pattern, to form the phosphor layer on the substrate.

(2) The process for forming a phosphor screen for display according to the above-mentioned (1), wherein the substrate is a flat transparent plate.

(3) The process for forming a phosphor screen for display according to the above-mentioned (1) or (2), wherein at the time of forming the phosphor layer on the substrate having the black matrix layer, the phosphor-containing ink composition is coated to fill apertures of the black matrix layer and also cover portions of the black matrix layer adjacent to said apertures.

(4) The process for forming a phosphor screen for display according to the above-mentioned (3), wherein the covered portions have a width of at least 10 μm.

### BRIEF DESCRIPTION OF THE DRAWINGS

FIG. 1 is a figure explaining a process for forming a three-color phosphor screen by one example of the present invention.

FIG. 2 is a figure illustrating the relation between the apertures of the BM layer formed by the process of the present invention and the contours of the phosphor layer pattern.

FIG. 3 is an enlarged view illustrating the relation between the BM layer C obtained by a conventional formation process and the phosphor layers B, G and R.

FIG. 4 is an enlarged view illustrating the relation between the BM layer C obtained by the formation process of the present invention and the phosphor layers B, G and R.

### DETAILED DESCRIPTION OF THE PREFERRED EMBODIMENTS

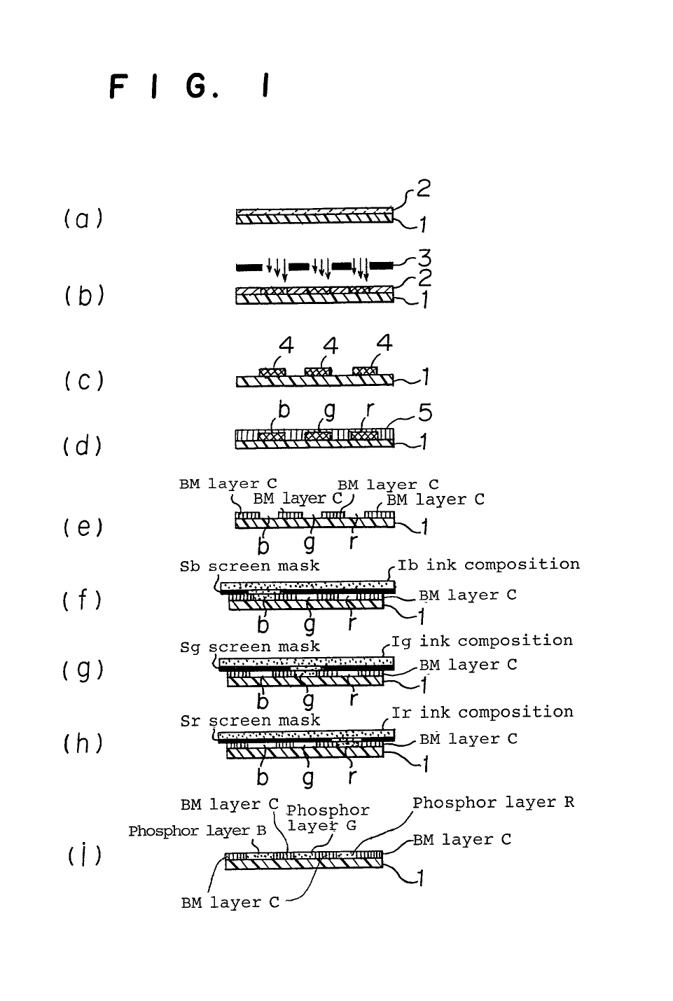

Now, the process for forming a phosphor screen for display having three color phosphor layers, according to the process of the present invention, will be described with reference to FIG. 1.

FIG. 1a illustrates a state that a photo-resist layer 2 is formed on a flat transparent substrate 1 of e.g. glass. A polyvinyl alcohol (PVA) and ammonium dichromate as a catalyst for photopolymerization, are added to water, followed by mixing to prepare a photoresist slurry, which is then coated on the substrate 1 on which a phosphor screen is to be formed, to form the photo-resist layer 2.

FIG. 1b illustrates a state that an ultraviolet light is irradiated on the portions b, g and r, on which three color phosphor layers B, G and R, respectively, are to be formed, through a mask (shadow mask) 3 having a pattern for three color phosphor layers, to cure the photo-resist layer 2 of the respective portions.

FIG. 1c illustrates a state that cured photoresist layers 4 are formed on the portions b, g and r, on which the color phosphor layers B, G and R, respectively, are to be formed, by washing off the uncured portion of the photo-resist layer 2 with water. FIGS. 1b and 1c illustrate so-called development treatment steps.

FIG. 1d illustrates a state that a slurry 5 having a photo-absorbing substance such as a graphite powder suspended in water, is coated on the whole area of the substrate 1.

FIG. 1e illustrates a state that the cured photo-resist layers 4 formed on the portions b, g and r, on which the color phosphor layers B, G and R, respectively, are to be formed, alone are separated off, by carrying out development again by using an aqueous hydrogen peroxide solution for releasing photo-resist layers, and a BM layer C is formed on the substrate 1 except on the portions b, g and r, on which the color phosphor layers B, G and R, respectively, are to be formed.

When the phosphor layers B, G and R to be formed later, are in a form of stripes, the BM layer C is in a form of stripes with a width of about from 20 to about 200 μm. Further, when the phosphor layers B, G and R to be formed later are in a form of dots or rectangles, the BM layer C covers the whole area of the phosphor screen except the portions b, g and r, on which the phosphor layers are to be formed. As the BM layer C thus obtained is formed by photolithography, a precise layer having sharp edges, and having no missing portion or un-uniformity in coating, can be obtained.

The BM layer C may be formed, as mentioned above, in such a manner that the photo-resist slurry is coated on the transparent substrate 1, an ultraviolet light is irradiated on the portions b, g and r, on which three color phosphor layers B, G and R, respectively, are to be formed, through a shadow mask 3, to cure these portions, and then the slurry 5 having a photo-absorbing substance such as a graphite powder suspended therein, is coated on the whole area of the substrate 1, and the portions b, g and r, on which the color phosphor layers B, G and R, respectively, are to be formed, are separated off by using a liquid for releasing photo-resist layers, to form the BM layer C (FIGS. 1a to 1e). Instead, the BM layer C may be obtained in such a manner that the photo-resist slurry 5 having a photo-absorbing substance such as a graphite powder or a metal oxide pigment suspended therein, is coated on the whole area of the transparent substrate 1, followed by exposure using a mask 3 having openings at the portions except the portions b, g and r, on which three color phosphor layers B, G and R, respectively, are to be formed, then the uncured portion of the photo-resist slurry 5 on the substrate 1, is washed off (development) to form the BM layer C (FIG. 1e). Then, as shown in FIGS. 1f to 1i, on the apertures of the BM layer C, i.e. on the portions b, g and r, on which the color phosphor layers B, G and R, respectively, are to be formed, each of three color phosphor-containing ink compositions Ib, Ig and Ir is successively coated in order by screen printing, to obtain a phosphor layer comprising the BM layer C and three color phosphor layers B, G and R.

Then, on the portions b, g and r on the substrate 1, on which the BM layer C is not formed, each of three color phosphor layers B, G and R, is successively coated by a screen printing method. The phosphor layers B, G and R are formed as follows. Firstly, three color phosphors are dispersed in a binder resin such as ethyl cellulose, followed by kneading to prepare phosphor-containing ink compositions Ib, Ig and Ir, respectively. Then, three color phosphor-containing ink compositions Ib, Ig and Ir, are successively coated in order by screen printing, by using three screen masks Sb, Sg and Sr, prepared to have a desired pattern for the respective phosphor layers B, G and R, while adjusting the portions of the screen masks so that the respective ink compositions are coated on the predetermined portions b, g and r, on which the color phosphor layers B, G and R, respectively, are to be formed, followed by drying (FIGS. 1f, g and h). In such a manner, a phosphor screen comprising the substrate 1, and the BM layer C and three color phosphor layers B, G and R formed on the substrate 1, can be obtained (FIG. 1i).

The screen masks Sb, Sg and Sr to be used for screen printing, are generally made of a stainless mesh as the material, and prepared to have a desired pattern. The pattern of each screen masks Sb, Sg and Sr, corresponds to the phosphor layer pattern, so that the phosphor layers can be printed in a form of dots, rectangles or stripes, corresponding to the apertures of the BM layer C.

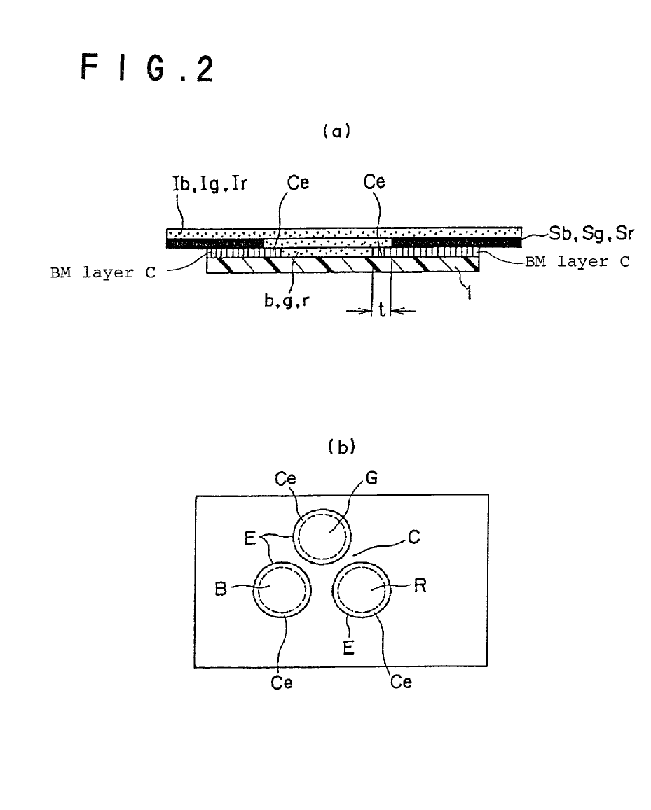

By using the screen masks Sb, Sg and Sr, the color phosphor-containing ink compositions Ib, Ig, and Ir are separately coated on the substrate 1 having the BM layer C by screen printing. At this time, as shown in FIG. 2a, the respective ink compositions Ib, Ig and Ir, are preferably coated to fill the apertures b, g and r, of the BM layer C, on which phosphor layers are to be formed, and also to cover peripheral portions Ce adjacent to the apertures b, g and r, of the BM layer C. Accordingly, screen masks Sb, Sg and Sr having larger apertures by a width (t) of the peripheral portions Ce to be covered, than the respective apertures b, g and r of the BM layer C, may be used.

FIG. 2b is a plane view illustrating a phosphor layer pattern coated by screen printing by using said screen masks Sb, Sg and Sr, observed from the coated side. The phosphor-containing ink compositions Ib, Ig and Ir are coated by screen printing so that the contours E of the phosphor layer pattern are located outside the apertures b, g and r of the BM layer C. With respect to the substrate 1 thus obtained, as the BM layer C is formed by photolithography, the edges of the apertures of the BM layer C are sharp, whereby contours of the phosphor layers B, G and R observed through apertures of the BM layer C are sharp. Even if there are missing parts or defects on edges along the peripheries of the phosphor layers, they will be covered by the covered portions on the BM layer C, whereby they will not be observed, and accordingly, an extremely high quality phosphor screen can be obtained.

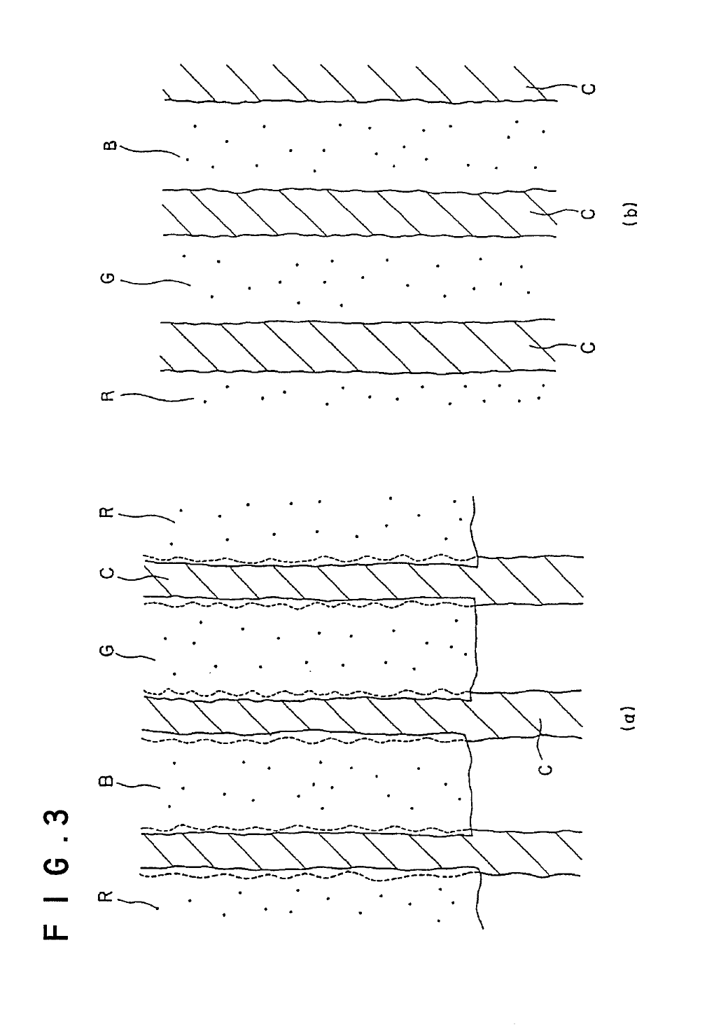

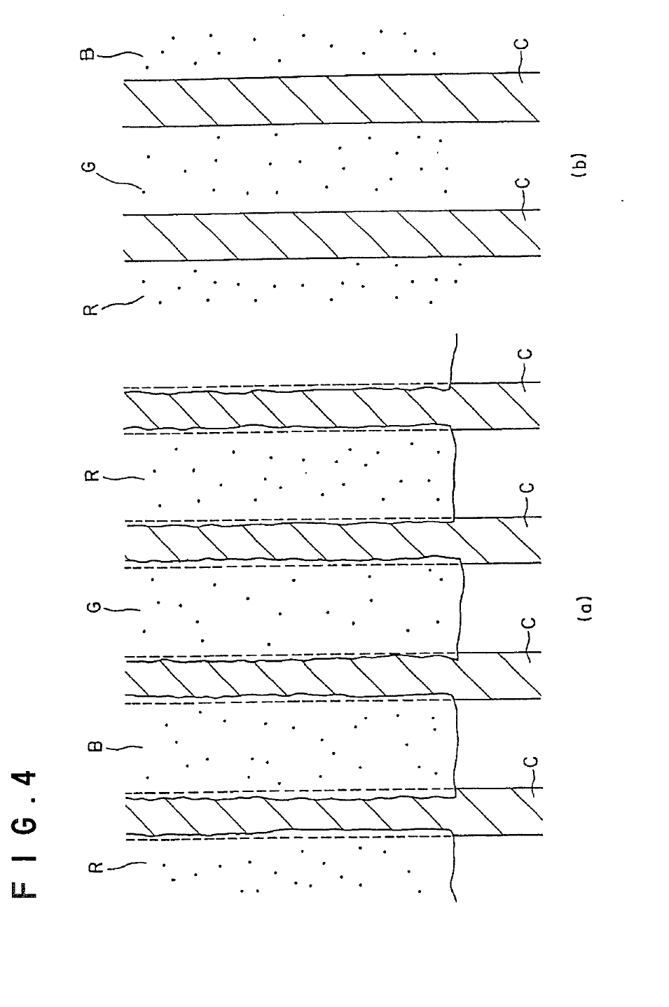

FIG. 3 schematically illustrates a conventional phosphor screen obtained by forming all the phosphor layers B, G and R and the BM layer C in a form of stripes by a screen printing method. FIG. 4 schematically illustrates a phosphor screen obtained by forming the BM layer C by photolithography, and then forming the phosphor layers B, G and R by a screen printing method, according to the method of the present invention.

FIG. 3a and FIG. 4a are figures illustrating the substrate 1 observed from the side on which the phosphor layer pattern is coated. FIG. 3b and FIG. 4b are figures illustrating the substrate 1 observed from the opposite side of FIG. 3a and FIG. 4a, respectively. Particularly, as evident from the comparison between FIG. 3b and FIG. 4b, in the phosphor layer of the present invention wherein the BM layer C is formed by photolithography (FIG. 4b), the contours, i.e. the boundaries, of the phosphor layers B, G and R observed through the apertures of the BM layer C, are clear, as compared with the phosphor layers wherein all the phosphor layers B, G and R and the BM layer C are formed by a conventional screen printing method (FIG. 3b). Accordingly, a phosphor screen having sharp edges can be obtained by the present invention.

In the present invention, at the time of coating the color phosphor-containing ink compositions Ib, Ig and Ir by screen printing, it is important to adjust the width (t) of the edges Ce of the BM layer C on which the respective color phosphor-containing ink compositions Ib, Ig and Ir are coated to cover, to be at least 10 μm. However, it is necessary to adjust the width so that a phosphor layer does not overlap the adjacent phosphor layers of different colors.

The phosphors to be used to form the phosphor screen of the present invention, are not particularly limited so long as they are excited to emit lights by high or low velocity electron lays, and phosphors to be used for a conventional phosphor screen for display may be employed, such as Y₂O₂S:Eu as a red phosphor, ZnS:Ag as a blue phosphor, and ZnS:Cu and Al as a green phosphor. In such a case, to increase the contrast of the displayed image, a phosphor having a pigment of the same color as the emitted light by the phosphor, attached on the surface, may be employed.

According to the process of the present invention, a displayed image having clear contours between the BM layer C and each of phosphor layers B, G and R, and having a high-resolution, can be obtained, as compared with a conventional phosphor screen wherein all the phosphor layers B, G and R and the BM layer C are formed by a screen printing method. Further, as different from the case where the BM layer is formed by a screen printing method, a phosphor screen having an uniform BM layer C with little irregularity, and having few defects on the layer due to contamination, can be obtained. Further, as compared with the case where the phosphor layers are formed by photolithography, apparatus and steps for phosphor layer formation can be simplified, whereby the loss of the phosphors in the phosphor screen formation can be minimized, and the cross contamination wherein a specific color phosphor layer is contaminated by other color phosphors, can be prevented, such being advantageous.

Now, the present invention will be explained with reference to Examples by using FIG. 1. However, it should be understood that the present invention is by no means restricted by such specific Examples.

### EXAMPLE

A photosensitive resin slurry having PVA and ammonium dichromate dissolved in water was coated on the whole surface of a flat glass plate 1 having a thickness of 3 mm, followed by drying to form a photosensitive resin layer (photo-resist layer) 2 (FIG. 1a).

Then, ultraviolet lights were irradiated thereon through a metal shadow mask 3 having a specific pattern with stripe apertures (FIG. 1b) followed by washing the glass plate with water, and the photo-resist layer 2 at the uncured portions which were not irradiated with ultraviolet lights, was removed, to form photo-resist layers 4 on the portions b, g and r, on which phosphor layers are to be formed later (FIG. 1c).

A graphite slurry having graphite suspended in water, was coated on the whole surface of the flat glass plate 1 having the photo-resist layers 4, followed by drying, to once form a graphite layer 5 on the whole surface (FIG. 1d), and the whole graphite layer 5 was washed by diluted hydrogen peroxide aqueous solution to separate off the cured portion of photo-resist layers 4 alone, to prepare a BM layer C in a form of stripes with a width of 120 μm at pitch of 350 μm (FIG. 1e).

A mixed composition comprising 100 parts by weight of a blue phosphor (ZnS:Ag), 10 parts by weight of ethyl cellulose and 60 parts by weight of terpineol, was mixed by a three-roll mill, to prepare a paste of an ink composition containing a blue phosphor (ZnS:Ag) and having the viscosity adjusted to be 50,000 cP.

The ink composition containing a blue phosphor (ZnS:Ag) was coated on the glass plate 1 by a screen printing method, by using a screen mask for screen printing with a width of the stripes of 250 μm at pitch of 1,050 μm, followed by drying at 130° C. for 30 minutes to prepare blue phosphor layers B.

In the same manner, by using an ink composition containing a green phosphor (ZnS:Cu,Al) and an ink composition containing a red phosphor (Y₂O₂S:Eu), green phosphor layers G and red phosphor layers R, respectively, were successively formed on the glass substrate 1 by a screen printing method, to produce a phosphor screen in three colors.

### Comparative Example

A phosphor screen of Comparative Example was produced by forming phosphor layers of blue, green and red by a screen printing method in the same manner as in Example, except that screen masks for screen printing with a width of the stripes of 120 μm at pitch of 350 μm were used, a mixed liquid comprising 20 parts by weight of ethyl cellulose and 150 parts by weight of terpineol based on 100 parts by weight of a graphite powder was subjected to a dispersion treatment by using a three-roll mill, and a graphite paste having the viscosity adjusted to be 100,000 cP was prepared, to form a BM layer C in a form of stripes with a width of 120 μm on the glass substrate by a screen printing method.

Phosphor screens obtained in Example and Comparative Example were compared with each other. As a result, when each substrate 1 was observed from the opposite of the side on which the phosphor layers were coated, in the phosphor screen of Example, the contours of the phosphor layers observed through apertures of the BM layer, i.e. the boundaries between the BM layer and phosphor layers are sharp, and the appearance of the phosphor layers were extremely excellent. However, in the phosphor screen of Comparative Example, there were problems in the appearance. Namely, defects such as irregularities, projections on the layer due to contamination, and local gatherings of graphite (black spots), are observed on the BM layer, and the boundaries were irregular.

Further, 80 sheets of the phosphor screens of Example and the phosphor screens of Comparative Example were prepared, respectively, whereupon they are visually observed by counting the number of defects in appearance such as irregularities, black spots due to contamination by a trace of extraneous substances such as dust, and local projections on the BM layer. As a result, defects were observed on five sheets in Example, whereas defects were observed on 48 sheets in Comparative Example. Accordingly, rate of defects occurrence on the phosphor screens could be suppressed to be extremely low in Example.

According to the present invention, by employing the above-mentioned constitutions, a uniform phosphor screen having a high resolution and sharp edges of the phosphor layers, can be formed. Further, said phosphor screen can be formed with a relatively simple formation apparatus, and the rate of defects during the formation can significantly be suppressed.

What is claimed is:

1. A process for forming a phosphor screen for display having a substrate, and at least a black matrix layer and a phosphor layer formed on the substrate, which comprises firstly forming the black matrix layer on the substrate by photolithography, and then coating a phosphor-containing ink composition by a screen printing method by using a screen mask corresponding to the phosphor layer pattern, to form the phosphor layer on the substrate.

2. The process for forming a phosphor screen for display according to claim 1, wherein the substrate is a flat transparent plate.

3. The process for forming a phosphor screen for display according to claim 1, wherein at the time of forming the phosphor layer on the substrate having the black matrix layer, the phosphor-containing ink composition is coated to fill apertures of the black matrix layer and also cover portions of the black matrix layer adjacent to said apertures.

4. The process for forming a phosphor screen for display according to claim 3, wherein the covered portions have a width of at least 10 μm.
